(19) United States
(12) Patent Application Publication
(10) Pub. No.: US 2005/0064293 A1
(43) Pub. Date: Mar. 24, 2005

(54) Lithium battery with a gel-type electrolyte and method for making the same

(76) Inventors: Chih-Hung Shen, Hsinchu (TW); Shun-Ming Huang, Taipei (TW); Chih-Ming Chen, Taipei (TW); Chih-Chang Lee, Hsinchu (TW)

Correspondence Address: SEYFARTH SHAW, 55 EAST MONROE STREET, SUITE 4200, CHICAGO, IL, 60603-5803, US

(21) Appl. No.: 10/668,092

(22) Filed: Sep. 19, 2003

(51) Int. Cl. H01M 10/40; H01M 2/02; H01M 6/10

(52) U.S. Cl. 429/303; 429/94; 429/176; 29/623.2

(57) ABSTRACT

A mixture of an electrolyte, a first oligomer and an initiating agent is emulsion polymerized to form a precursor solution with a micro void structure for the gel-type electrolyte. A current available jelly-roll is put into an aluminum foil packet, and the precursor solution is then injected into the packet, which is then sealed and baked so that a highly conductive gel-type electrolyte is disposed inside and outside the jelly-roll. The lithium battery with the gel-type electrolyte is very stiff, reliable, and free from expansion and electrolyte leakage.

### BACKGROUND OF THE INVENTION

(A) Field of the Invention

The present invention relates to a lithium battery with a gel-type electrolyte and method for making the same, and more particularly, to a lithium battery with a gel-type electrolyte synthesized by an emulsion polymerization.

(B) Description of the Related Art

In recent years, the use of portable electronic devices such as mobile phones, notebook computers, personal digital assistants, digital cameras and so forth, has widely expanded and are now required to be light, slim, short and small. The size and weight of each element of the portable electronic devices are so strictly limited to meet the requirements, that the power supply, that is, a lithium battery, influences the weight and shape of the portable electronic devices in most cases.

The lithium battery is strictly limited by volume and weight, and along with the requirements for electrical safety, mechanical strength and resistance to environmental variations, high standards for quality control are also imposed. In particular, the product must pass some strict mechanical experiments, such as impact tests, crush tests and drop tests. All of these tests are to prevent the product, under regulated test conditions, from leakage or short-circuiting even when an external force is applied.

According to the prior art method for manufacturing lithium batteries, a conductive article is first coated separately with an active positive material and an active negative material to form positive and negative electrodes. A separating film is then used to separate the positive and negative electrodes to form a jelly-roll for a lithium battery. The jelly-roll and liquid electrolyte is then encapsulated in a container to complete the lithium battery. The prior art lithium battery is commonly encapsulated in a metallic container. However, since the metallic container is thick, heavy, difficult to seal, and only able to be processed into a rectangular shape, there is poor variation with the lithium battery encapsulated in a metallic container. Even if the thickness of the metallic container is reduced from 8 mm to 4 mm, it still has difficulty meeting the requirement of being light, slim, short and small.

Instead of a metallic container, aluminum foil compression molding is used in the encapsulation of the secondary battery, and in recent years, aluminum foil soft encapsulation is being used increasingly. However, since aluminum foil has a mechanical strength much lower than that of the metallic container, and it is easy for fluid leakage problems to occur during mechanical strength tests. Recently, the lithium battery industry is attempting to develop gel-type lithium batteries, which can avoid the fluid leakage problem by sealing the liquid electrolyte in a gel-type plastic polymer.

Among batteries using aluminum foil encapsulation packets, polymer batteries are predominantly used to for thinning the size of the battery, and the polymer electrolyte can efficiently avoid the fluid leakage problem and enhances the safety of batteries. For the moment, only the Sony company has put forward such products successfully, wherein the electrolyte and the plastic polymer are spread on the electrode, which is then wound with separating film to form the jelly-roll. The jelly-roll is then put into an aluminum foil packet directly and encapsulation is performed without the injected electrolyte to complete the battery. However, such batteries can not be manufactured without precision equipment, and all of the manufacturing processes, except for the manufacturing of the electrodes, need to be completed in a clean room environment, thus the manufacturing process is very complicated and the cost is very high.

### SUMMARY OF THE INVENTION

The first objective of the present invention is to provide a lithium battery with a gel-type electrolyte and method for making the same, which uses emulsion polymerization to synthesize the gel-type electrolyte so as to increase the reliability of the process and structural safety.

The second objective of the present invention is to provide a simplified method for making the lithium battery with a gel-type electrolyte without the need for high precision manufacturing apparatus, wherein the simplified method is similar to the prior art method with an additional thermal baking process.

The third objective of the present invention is to provide a gel-type electrolyte having a micro void structure for a lithium battery, wherein a plastic polymer will possess many uniform voids after the emulsion polymerization is performed so that the electrical properties are better, the cycle number and the discharging performance are improved.

In order to achieve the above-mentioned objective and avoid the problems of the prior art, the present invention provides a lithium battery and the method for making the same. According to the present invention, a solution substantially consisting of an electrolyte, a first oligomer, and an initiating agent are emulsion polymerized to form a precursor with a micro void structure for the gel-type electrolyte. A jelly-roll current available for the lithium battery is put into an aluminum foil packet, the precursor for the gel-type electrolyte is then injected into the aluminum foil packet, and a thermal baking process is performed to form a conductive gel-type electrolyte with voids disposed inside and outside the jelly-roll. The aluminum foil packet becomes stiff after the thermal baking process and an activation process is then performed to complete a lithium battery with high reliability, electrical safety, and free of the electrolyte leakage and expansion problems.

### BRIEF DESCRIPTION OF THE DRAWINGS

Other objectives and advantages of the present invention will become apparent upon reading the following description and upon reference to the accompanying drawings in which:

FIG. 1 is a schematic diagram showing the emulsion interaction on the gel-type electrolyte according to the present invention;

FIG. 2 is a diagram showing the conductivity before the thermal baking process is performed according to the first embodiment of the present invention;

FIG. 3 is a diagram showing the conductivity after the thermal baking process is performed according to the first embodiment of the present invention;

FIG. 4 is a diagram showing the discharging efficiency according to the second embodiment of the present invention; and

FIG. 5 is diagram showing the relationship between the charging/discharging properties and the cycle number according to the present invention.

### DETAILED DESCRIPTION OF THE INVENTION

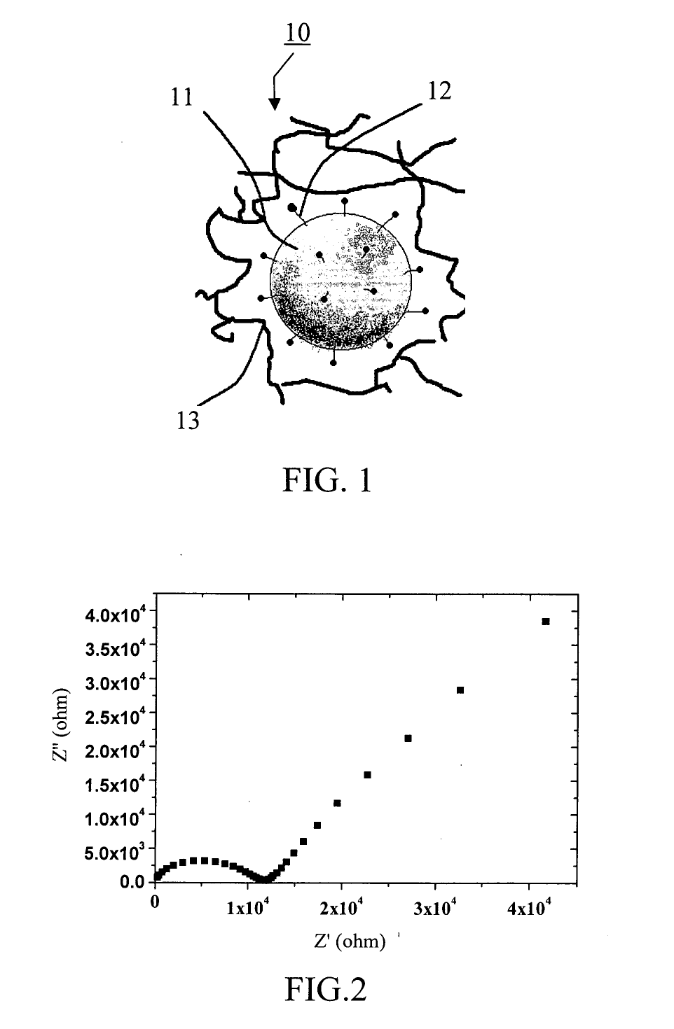

FIG. 1 is a schematic diagram showing the emulsion interaction on the gel-type electrolyte according to the present invention. The gel-type electrolyte substantially consists of a plurality of micelle units 10. The micelle unit 10 comprises a micro drop 11 and a first oligomer 12 having at least one nonpolar group and at least one polar group. The micro drop 11 of electrolyte is polar and the nonpolar group of the first oligomer 12 with interfacial activity is outward and its polar group is inward to adhere to the surface of the micro drop 11 to form the basic structure of the micelle unit 10.

The present invention uses emulsion polymerization to prepare a solution substantially consisting of an electrolyte, a first oligomer and an initiating agent, wherein the solution is a precursor for the gel-type electrolyte and has a micro void structure. A second oligomer 13 can be mixed with the precursor solution to enlarge the voids so that ions can pass in and out more easily, wherein the second oligomer 13 interconnected with each other and surrounds the first oligomer 12. The emulsion polymerization can be accelerated by thermal baking or UV-irradiation to increase the chemical reaction coordination, loosening each micelle structure for rearrangement to proceed. If a suitable accelerator is added, the reaction can be completed even at room temperature to form the gel-type electrolyte with micro voids naturally.

The processes for manufacturing the lithium batteries with the above-mentioned gel-type electrolyte are described therein. The above-mentioned jelly-roll is manufactured according to the prior art method for lithium batteries, and both the wound type and stacked type are applicable to the present invention. According to the present invention, the jelly-roll is put into a molding aluminum foil packet, and a solution substantially consisting of the electrolyte, the first oligomer and the initiating agent is injected into the aluminum foil packet, wherein the solution is so called gel-type electrolyte precursor. The precursor solution has 50 to 95 weight percent of the electrolyte, such as EC/DMC/EMC/1MliPF₆, used in the prior art lithium ion lithium battery, 5 to 50 weight percent of first oligomer selected from the acrylate oligomer series. The acrylate oligomer is classified into a single-function oligomer and a multi-function oligomer (i.e., more than 2 function groups), and the ratio of the single-function oligomer to the multi-function oligomer in the first oligomer is between 5/95 and 95/5 (by weight). The chemical structural formula of the first oligomer is shown:

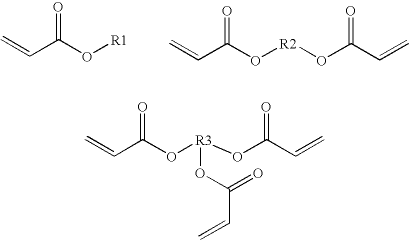

Wherein R1 is H, alkyl, vinyl, silane or siloxyl group, and R2 and R3 is alkyl, vinyl, silane or siloxyl group. The initiating agent is a free radical initiating agent, such as BPO, AIBN or hydroperoxide, and the content in the solution is between 0.1 and 5 weight percent with respect to the first oligomer 12.

There are the jelly-roll and the precursor solution of the gel-type electrolyte in the aluminum foil packet, and a special holder is required here to seal the packet and ensure the space of the internal volume for encapsulating through compression molding. In order to accelerate the emulsion polymerization of the precursor solution for the gel-type electrolyte, the encapsulated packet is put into a circulation oven and baked at 40-100° C. for 1 to 12 hours. After the baking process, an activation step is performed later to complete the lithium battery.

### DESCRIPTION OF THE FIRST EMBODIMENT

Three samples, 1-3, of gel-type electrolyte having 90 weight percent of EC/DMC/EMC (1/1/1) 1M LiPF₆ and 10 weight percent of different first oligomers are prepared. The first oligomer is a mixture having 15 weight percent of 3-methacryloxypropyltris(trimethylsilane)silane oligomer and 85 weight percent of a multi-functional acrylate oligomer (polyethylene glycol 200 diacrylate), (tetraethylene glycol diacrylate) or (highly ethoxylated TMPTA), respectively, for the samples, 1-3. Samples 1-3 all use the free radical initiating agent AIBN (1 weight percent with respect to the first oligomer) and a thermal baking process is performed in a circulation heating oven at 60° C. for 8 hours. The electrical conductivity data of the electrolyte before and after mixing with three different first oligomers is shown in Table 1.

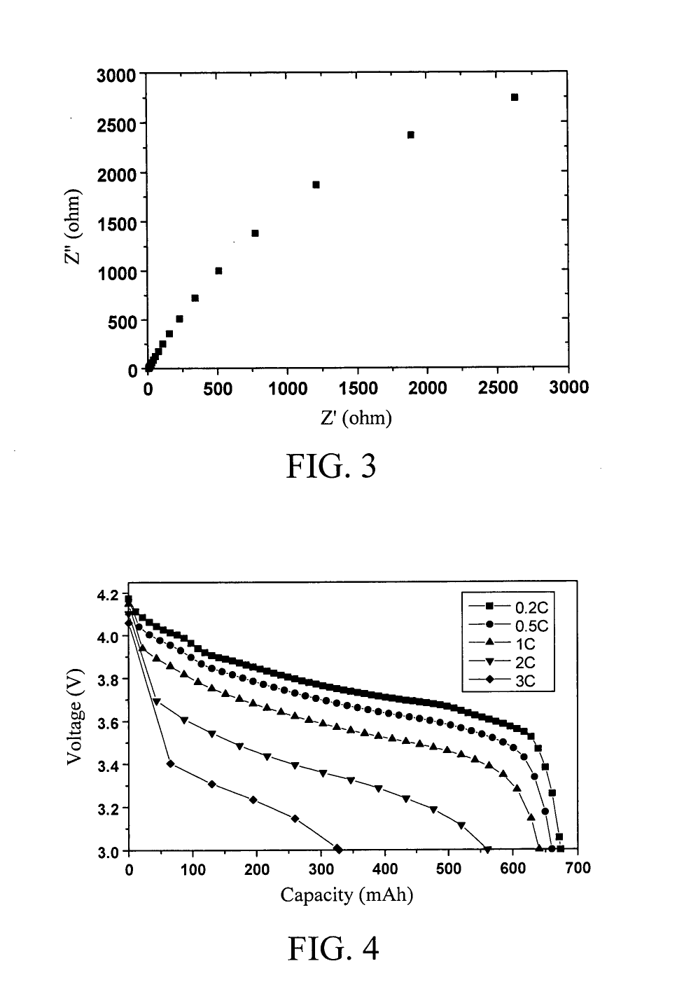

FIG. 2 is a diagram showing the conductivity of Sample 3 before the thermal baking process is performed according to the first embodiment of the present invention, while FIG. 3 is a diagram showing the conductivity of Sample 3 after the thermal baking process is performed according to the first embodiment of the present invention. FIG. 2 and FIG. 3 show the impedance when an alternating current is applied, wherein the electrical conductivity and resistance value are reciprocal values mutually. As shown in FIG. 2, the electrical conductivity is quite low at low frequencies due to that there is an interface before the thermal baking process is performed. As shown in FIG. 3, the electrical conductivity after the thermal baking is much higher compared to the unbaked sample since the gel-type electrolyte micelle are rearranged in order and have more uniform size after baking.

TABLE 1

| | Prior art | | | |
|---|---|---|---|---|
| | Electrolyte | Sample 1 | Sample 2 | Sample 3 |
| composition | EC/DMC/ | EC/DMC/ | EC/DMC/ | EC/DMC/ |
| | EMC/1M | EMC/1M | EMC/1M | EMC/1M |
| | LiPF6 | LiPF₆ + | LiPF₆ + | LiPF₆ + |
| | | PEG200 + | TTEGDA + | HEOTMPTA + |
| | | Si-silane | Si-silane | Si-silane |
| | | (recipe 1) | (recipe 2) | (recipe 2) |
| conductivity | 7.6 × 10⁻³ | X | X | X |
| before mixing | (S/cm) | | | |
| conductivity | | 2.7 × 10⁻³ | 2.4 × 10⁻³ | 3.22 × 10⁻³ |
| after mixing | | (S/cm) | (S/cm) | (S/cm) |

### DESCRIPTION OF THE SECOND EMBODIMENT

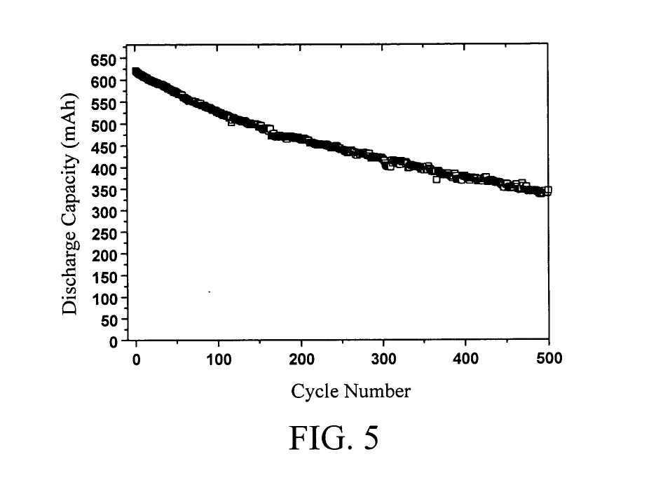

FIG. 4 is a diagram showing the discharging efficiency according to the second embodiment of the present invention, and FIG. 5 is diagram showing the relationship between the charging/discharging properties and the cycle number according to the present invention. According to the second embodiment of the present invention, a lithium battery has a rectangular shape of 5.0 (thickness)×30 (width)×48 (length) mm, the positive electrode of the jelly-roll is made of LiCoO₂, the negative electrode is made of artificial graphite, and the capacity of the battery is designed to be 650 (mAh). The gel-type electrolyte substantially consists of EC/DMC/EMC (1/1/1) 1M LiPF₆ (90 wt %) and the first oligomer sample 3 (10 wt %), and uses free radical initiating agent AIBN (1 wt % with respect to the first oligomer). The sample is thermally baked in a circulation heating oven at 60° C. for 8 hours. As shown in the diagrams, the capacity is kept over 60% after 500 cycles when the charging/discharging condition is 1 C.

The above-described embodiments of the present invention are intended to be illustrative only. Numerous alternative embodiments may be devised by those skilled in the art without departing from the scope of the following claims.

1. A lithium battery comprising an aluminum foil packet, a gel-type electrolyte and a jelly-roll, the gel-type electrolyte having a plurality of micelle units, and the micelle unit comprising:
a micro drop of electrolyte; and
a plurality of first oligomers with interfacial activity, the first oligomer having at least one nonpolar group and at least one polar group for adhering to the surface of the micro drop.

2. The lithium battery of claim 1, wherein the micelle unit further comprises a plurality of second oligomers interconnected with each other and surrounding the first oligomer with interfacial activity.

3. A method for making a lithium battery, comprising the steps of:
disposing a jelly-roll in an aluminum foil packet;
injecting a mixture of a first oligomer, an electrolyte and an initiating agent into the aluminum foil packet;
molding the aluminum foil packet by sealing and compressing;
baking the mixture to form a gel-type electrolyte; and
performing an activation process.

4. The method for making a lithium battery of claim 3, wherein the first oligomer is an acrylate oligomer and is in an amount of from 5 to 50% by weight, based on the weight of the mixture.

5. The method for making a lithium battery of claim 4, wherein the first oligomer comprises a single-function oligomer and a multi-function oligomer, the ratio of the single-function oligomer to the multi-function oligomer is between 5/95 and 95/5, and the first oligomer has a polar group and a nonpolar group.

6. The method for making a lithium battery of claim 5, wherein the polar group comprises a functional group selected from the group consisting of C═O, C═N and C—O.

7. The method for making a lithium battery of claim 5, wherein the nonpolar group of the first oligomer comprises t-Bu-, R₃Si— and R—, and the R— is selected from the group consisting of hydrogen, the alkyl, the vinyl, the silane and the siloxy.

8. The method for making a lithium battery of claim 4, wherein the electrolyte is EC/DMC/EMC (1/1/1) 1M LiPF₆, and is in an amount of from 50 to 95% by weight, based on the weight of the mixture.

9. The method for making a lithium battery of claim 4, wherein the initiating agent is a free radical initiating agent and is in an amount of from 0.1 to 5% by weight, based on the weight of the first oligomer.

10. The method for making a lithium battery of claim 4, wherein the temperature for baking the mixture is between 40 and 100° C. for 1 to 12 hours.
